(19) United States
(12) Patent Application Publication
(10) Pub. No.: US 2021/0331133 A1
(43) Pub. Date: Oct. 28, 2021

(54) ECONOMIC AND ECO-FRIENDLY DYNAMIC MIXER

(71) Applicant: SP Advanced Engineering Materials Pvt. Ltd., Mumbai (IN)

(72) Inventors: Arindam Mukherji, Thane (IN); Guruprasad Namdev Wakure, Osmanabad (IN)

(21) Appl. No.: 17/242,090

(22) Filed: Apr. 27, 2021

(30) Foreign Application Priority Data
Apr. 27, 2020 (IN) 202021017970

(51) Int. Cl. B01J 19/00; B01J 19/06; B01J 19/18; C08G 63/78

(52) U.S. Cl. CPC B01J 19/0066; C08G 63/785; B01J 19/18; B01J 19/06

(57) ABSTRACT

A dynamic mixer to mix at least one curing agent and at least one resin system in the proportion of at least 2.5:100 to obtain a homogenous curative composition, wherein said mixer comprises a stirring chamber (5) provided with a motorised stirrer (4) suspended from the top of the chamber (5) and a siphon (6) at the bottom; at least one inlet hose (h1) connected to the stirring chamber at one end and pumping means (p1) at other end; the pumping means (p1) pump at least one curing system to the stirring chamber through the at least one inlet hose (h1); at least one inlet hose (h2) connected to the stirring chamber at one end and pumping means (p2) at other end; the pumping means (p2) pump at least one resin system to the stirring chamber through the at least one inlet hose (h2); and frame to setup the dynamic mixer. The proportion of diameter (A) of the stirring chamber (5); length (B) of the stirring chamber (5) from a top closure to a bottom opening of the chamber (5); and the length (C) from the bottom opening of the chamber (5) and a top of the siphon (6) may vary only in the ratio of 1:(2.6-3.0):(1.1-1.3) i.e. [(A):(B):(C)] to obtain the homogenous curative composition comprising 2.5 phr curing system per resin system.

### RELATED APPLICATIONS

This application claims priority under 35 U.S.C. § 119 to IN Application 202021017970, filed Apr. 27, 2020 such IN Application also being incorporated by reference herein in its entirety.

### FIELD

The present invention relates to the technical field of mixing devices, in particularly to a simple, an economic and eco-friendly dynamic mixer.

### BACKGROUND

Dynamic mixer is a kind of high-efficiency mixing equipment that has moving parts. Its' basic working mechanism is to mix the ingredients into a homogeneous mixture or to form a good dispersion.

When the dynamic mixer is used to prepare curative composition by the addition of polymers or monomers with one or more curatives along with other suitable additives in bulk quantity then this composition is transferred to the desired place where curative composition needs to be deposited manually or through pipes.

One of the disadvantages is the spillage of the curative composition while transferring to the desired place. Another major disadvantage is that the composition may get cured depending upon several factors and the same can jam the mixer as well as block the outlet pipes. In such situation, one need to replace mixer as well as outlet pipes and this replacement causes major loss. There is also restriction on number and amount of curing agents used to prepare the curative composition in the dynamic mixer. Till date, only one curing agent was used in the dynamic mixer and the proportion of the curing agent to the resin system used is 20:100.

### SUMMARY

Accordingly, the main object of the present invention is to provide a simple, an economic and an eco-friendly dynamic mixer which will help to prepare the desired quantity of curative composition and provide an outlet to transfer the resin mixture continuously to the desired place to avoid loss of material at the same time.

Another object of the present invention is to provide the simple, economic and eco-friendly dynamic mixer which will eliminate the spillage of the composition while transferring to the desired place.

Yet another object of the present invention is to provide the simple, economic and eco-friendly dynamic mixer which will eliminate undue gelling thereby reducing jamming and reducing the material loss thereof.

Still another object of the present invention is to provide the continuous homogeneous composition.

Still another object of the present invention is to provide the simple, economic and eco-friendly dynamic mixer which will be less costly.

Still another object of the present invention is to provide the simple, economic and eco-friendly dynamic mixer, where human intervention is zero.

Still another object of the present invention is to provide the simple, economic and eco-friendly dynamic mixer, where two or more curing agents can be added to the curative composition without jamming thereby eliminating the restriction on the number of curing agents to be used in the dynamic mixer to prepare the curative composition.

Still another object of the present invention is to provide the simple, economic and eco-friendly dynamic mixer, where the curative composition comprises substantially less curing agents in a proportion of 2.5:100 (a curing agent(s)/system: a resin system), thereby overcoming the proportion of the curing agent to the resin system used in the existing art and making it very efficient.

An additional object of the invention is to provide a simple, an economic and eco-friendly dynamic mixer, wherein the mixer follows two-part mixing principle by dividing components into a part (A) as a resin system and a part (B) as a curing system; said curing system comprises at least one curing agent along with a suitable additive including mould release agent; said resin system comprises at least one resin along with a suitable additive and a filler; and fed into the mixer to achieve curative composition comprising at least 2.5 phr curing system (B) per resin system.

### BRIEF DESCRIPTION OF THE DRAWINGS

FIG. 1 illustrates the schematic structural diagram of the simple, economic and eco-friendly dynamic mixer of the present invention.

FIG. 2 illustrates the schematic structural diagram of the master tank used to store the curative composition/liquid composition.

FIG. 3 illustrates the exploded view of the stirring chamber with the stirrer and the siphon with critical dimensions.

### DETAILED DESCRIPTION

The present invention as described below, it is to be understood that this invention is not limited to particular embodiments, drawings, methodologies and materials described, as these may vary as per the person skilled in the art. It is also to be understood that the terminology used in the description is for the purpose of describing the particular embodiments only and is not intended to limit the scope of the present invention.

Before the present invention is described, it is to be understood that unless defined otherwise, all technical and scientific terms used herein have the same meaning as commonly understood by one of ordinary skill in the art to which this invention belongs. Further, it is to be understood that the present invention is not limited to the methodologies and materials similar or equivalent to those described herein can be used in the practice or testing of the present invention, the preferred methods and materials are described, as these may vary within the specification indicated. Unless stated to the contrary, any use of the words such as “including,” “containing,” “comprising,” “having” and the like, means “including without limitation” shall not be construed to limit any general statement that it follows to the specific or similar items or matters immediately following it. Embodiments of the invention are not mutually exclusive, but may be implemented in various combinations. The described embodiments of the invention and the disclosed examples are given for the purpose of illustration rather than limitation of the invention as set forth the appended claims. Further the terms disclosed embodiments are merely exemplary methods of the invention, which may be embodied in various forms.

It is also to be understood that the terms “a”, “an”, “the” and like are words for the sake of convenience and are not to be construed as limiting terms. Moreover, it will be understood that the illustrations are for the purpose of describing a particular exemplary embodiment of the invention and are not limited to the invention thereto.

The term “resin system” intends to cover a system comprising a resin along with at least one suitable additive and a filler.

The term “curative system” intends to cover a system comprising at least one curing agent along with at least one suitable additive including mould release agent.

The term “curative composition” is also called as a “formulated resin composition” and it intends to cover the homogenous composition obtained after mixing the resin system with the curative system.

The term “phr” means parts per hundred resin or resin system.

In order to solve the problems like jamming of the dynamic mixer itself and/or the outlets of the mixer and thereby replacing the entire mixer and/or the outlet pipes with new one, the present invention provides a simple, an economic and an eco-friendly dynamic mixer which will help to prepare the desired quantity of curative composition and provide the outlet to transfer the mixture at the desired place to avoid loss of material at the same time. It also eliminates the spillage of the curative composition while transferring to the desired place. It eliminates jamming and loss and thus makes it less costly. It eliminates the restriction on number of curing agents used and substantially decreases the amount of curing agents used.

In view of the above-mentioned drawbacks, the present invention proposes to provide a simple, an economic and eco-friendly dynamic mixer which will help to prepare the desired quantity of curative composition and provide an outlet to transfer the same at desired place to avoid loss of material and at the same time it will avoid jamming of the mixer.

This mixer is developed to prepare the curative composition comprising substantially less curing agents in a proportion of 2.5:100 (a curing agent(s)/system:a resin system), thereby overcoming the proportion of the curing agent as well as number of curing agents to the resin system used in the existing art and making it very efficient.

This mixer reduces undue gelling due to prolonged standing of formulated resin and thereby reduces jamming of the mixer and material loss due to gelling.

This mixer is developed to limit the predefined quantity of the homogenous mixing system and supply the curative composition at the desired place of the end application, thereby encountering negligible material loss in transit.

In one of the embodiments of the invention, there is provided a dynamic mixer to mix at least one curing system and at least one resin system in the proportion of at least 2.5:100 to obtain a homogenous curative composition,

Wherein Said Mixer Comprises:

a stirring chamber (5) provided with a motorised stirrer (4) suspended from the top of the chamber (5) and a siphon (6) at the bottom;

at least one inlet hose (h1) connected to the stirring chamber at one end and pumping means (p1) at other end; the pumping means (p1) pump at least one curing system to the stirring chamber through the at least one inlet hose (h1);

at least one inlet hose (h2) connected to the stirring chamber at one end and pumping means (p2) at other end; the pumping means (p2) pump at least one resin system to the stirring chamber through the at least one inlet hose (h2); and

frame to setup the dynamic mixer.

Typically, one arm of the siphon is connected to stirring chamber at one end and other arm of the siphon is connected to an outlet pipe at the other end.

Typically, the driving system of the stirrer may be mechanical including means to drive the wheel like shaft, driver, etc. or automated driving system.

Typically, the pumping means (p1) and (p2) includes all types of pumps of suitable capacity for the application. The pumps used in the invention are gear pumps and variable frequency drive attached to it in order to vary the discharge independently in order to obtain different mixing ratios.

Typically, the outlet pipe connected to the siphon dispenses the curative composition to a master tank through the primary dispensing port. The master tank comprises of several small dimensional portable tanks. Each portable tank is connected to the sub-dispensing inlet port of predefined height. All the portable tanks are connected through the multiple sub-dispensing inlet ports to a primary dispensing port. All portable tanks are arranged at predefined intermittently elevated heights.

Alternatively, the length of the outlet pipe at other end of the siphon is suitable to reach the place where the curative composition is used.

Alternatively, the curative composition from the stirring chamber will be transferred through the outlet pipe manually at the desired place of use.

The dynamic mixer of the invention follows two-part mixing principle by dividing components into the part (A) as the resin system and the part (B) as the curing system, said curing system comprises at least one curing agent along with a suitable additive including mould release agent; said resin system comprises at least one resin along with a suitable additive and a filler; and fed into the mixer to achieve curative composition comprising at least 2.5 phr curing system (B) per resin system.

In one of the embodiments of the invention, the desired quantities of at least one resin system and at least one curing system are added through inlet hoses connected to the stirring chamber through pumping means. The combined content of the resin system(s) and the curing system(s) in the stirring chamber is always maintained at the level of the siphon's height. The siphon level is maintained at ⅓rd of the stirring chamber. It is very important for the present invention to maintain the level of the content of the stirring chamber to that of the siphon level to make consistent and continuous supply of the curative mixture at desired place and if at all there is jamming due to curing in the process then the loss is minimal.

The resin system (Part A) comprises at least one resin, a suitable additive and filler.

The curing system (Part B) comprises at least one curing agent and a suitable additive including mould release agent.

In another embodiment of the invention, there is a provision in the present invention to pump more than one curing agents by increasing the number of inlet hoses connected to the stirring chamber through pumping means to pump the curing agents to the chamber and to prepare the curative composition.

Typically, the present invention can pump five different curing agents through five inlet hoses in the stirring chamber through pumping means to prepare the curative composition.

In another embodiment of the invention, there is a provision in the present invention to pump more than one resin systems by increasing number of inlet hoses connected to the stirring chamber through pumping means to pump the curing agents to the chamber and to prepare the curative composition.

Typically, in the present invention, at least one curing agent and at least one resin system is pumped into the stirring chamber through the inlets through pumping means in the proportion of at least 2.5:100. At such low concentration, the uniform mixing is carried out in the dynamic mixer of the invention to produce the curative composition.

In another embodiment of the invention, the curing agents and the resin system can be replaced by any number of liquid components, particularly at least five liquid components to be added to the dynamic mixer.

Typically, in the present invention, at least five liquid components are pumped into the stirring chamber through the inlets through pumping means in the proportion where at least one of the liquid components used is at least 2.5 phr per composition. At such low concentration, the uniform mixing is carried out in the dynamic mixer of the invention to produce the homogeneous composition without spillage or loss due to jamming.

Typically, the curing system and resin system is pumped into the chamber by the pumping means p1 and p2 through inlet hoses h1 and h2 at a speed of 0.1 to 0.2 liter/minute and 3.4 to 3.96 liter/minute respectively.

Typically, the curing system and the resin system are mixed in the chamber (5) with a residence time in the range of 40 to 67 seconds to siphon out the homogenous composition.

Typically, the curative composition or homogeneous composition is siphoned out from the chamber through outlet hose at 3 to 4 liter/minute.

### Detailed Description of the Accompanying Drawings

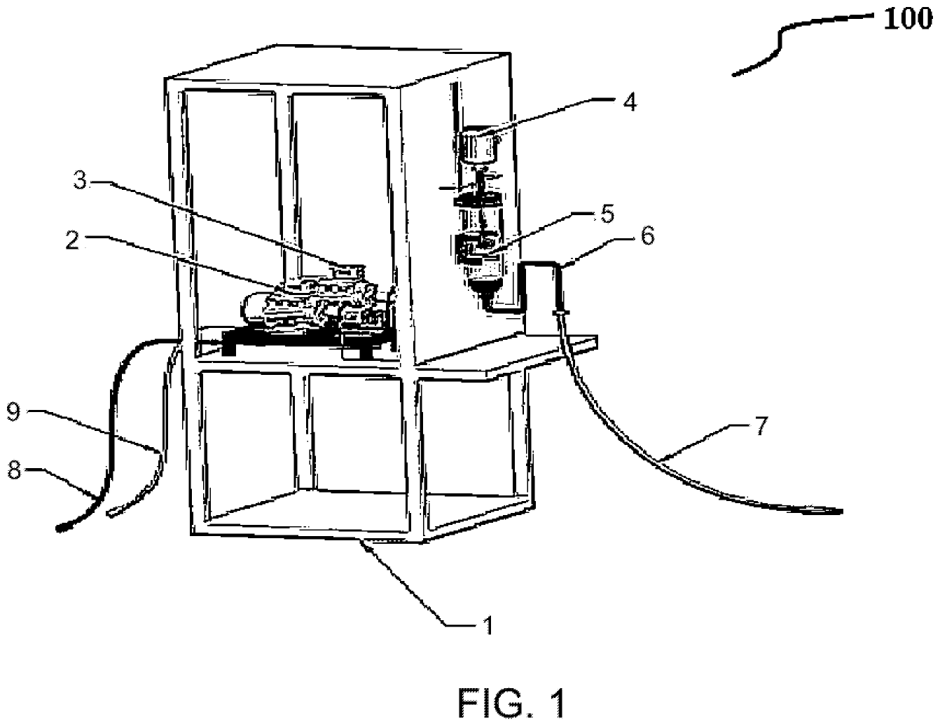

FIG. 1 illustrates the schematic structural diagram of the simple, economic and eco-friendly dynamic mixer of the present invention. The dynamic mixer (100) consisting of an inlet hose (8 i.e. (h1)) for the curing system, the pumping means (2 i.e. p1) to pump the curing system, an inlet hose (9 i.e. (h2)) for the resin system, the pumping means (3 i.e. (p2)) to pump the resin system, stirrer (4), stirring chamber (5), siphon (6) and outlet pipe (7) to discharge the curative composition. The dynamic mixer is fitted into the frame (1). The dynamic mixer (100) comprises a stirring chamber (5), a stirrer (4) suspended from the top of the chamber (5) and connected to top closure of the chamber (5) and a siphon (6) connected at the bottom of the chamber. The arm (6a) of the siphon (6) is connected to the stirring chamber (5) at one end and other arm (6b) of the siphon (6) is connected the outlet pipe (7) at the other end to discharge the curative composition. The stirring chamber (5) is also connected to an inlet hose (8) through a pumping mean (2) and an inlet hose (9) through a pumping mean (3) to pump the curing system and the resin system respectively. The dynamic mixer (100) of the present invention is fitted into the frame (1) to setup the dynamic mixer.

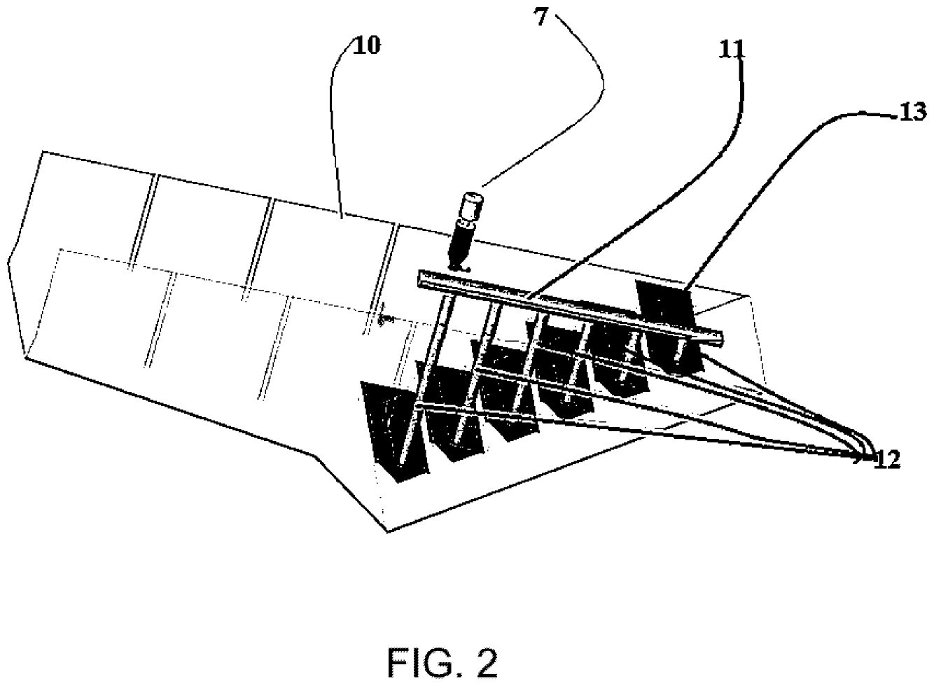

FIG. 2 illustrates the schematic structural diagram of a master tank used to store the curative composition/liquid composition mixed in the dynamic mixer of the invention. The outlet pipe (7) which dispenses the curative composition is connected to a master tank (10) through a primary dispensing port (11). The master tank comprises several small dimensional portable tanks (13). Each portable tank (13) is connected to the sub-dispensing inlet port (12) of predefined height. All the portable tanks (13) are connected through the multiple sub-dispensing inlet ports (12) to the primary dispensing port (11). All portable tanks are arranged at predefined intermittently elevated heights.

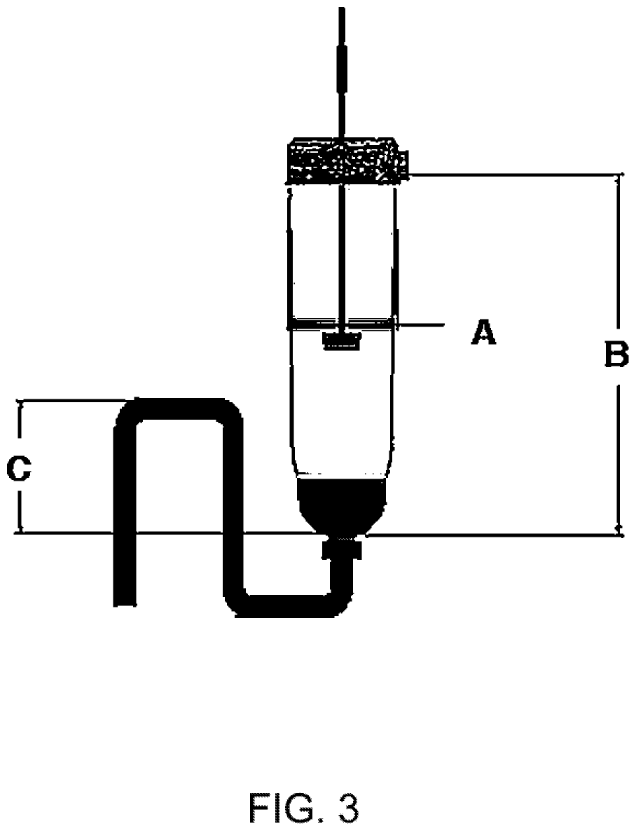

FIG. 3 illustrates the exploded view of the stirring chamber (5) with the stirrer (4) and the siphon (6) with critical dimensions of the simple, economic and eco-friendly dynamic mixer of the present invention. The dimensions including the diameter (A) of the stirring chamber (4), length (B) of the stirring chamber (5) from a top closure to a bottom opening of the chamber (4), and length (C) from the bottom opening of the chamber (5) and a top of the siphon (6) are very critical to facilitate the preparation of the homogeneous curative composition comprising substantially less amounts of curing system in a proportion of 2.5:100 (curing agent(s)/system:resin system);

facilitate the mixing of at least two liquid components by replacing the curing system and the resin system in the proportion 2.5:100 to prepare the homogeneous composition; and

facilitate the mixing of at least five liquid components where at least one of the liquid components is used at least 2.5 phr and at such low concentration, the uniform mixing is carried out in the dynamic mixer of the invention to produce the homogeneous composition which is otherwise difficult to mix.

Typically, the proportion of diameter (A) of the stirring chamber (5); length (B) of the stirring chamber (5) from a top closure to a bottom opening of the chamber (5); and the length (C) from the bottom opening of the chamber (5) and a top of the siphon (6) may vary only in the ratio of 1:(2.6-3.0):(1.1-1.3) i.e. [(A):(B):(C)] to obtain the homogenous curative composition comprising 2.5 phr curing system per resin system.

For Example:

Typically, the diameter (A) of the stirring chamber (5) is 125 mm.

Typically, the length (B) of the stirring chamber (5) from a top closure to a bottom opening of the chamber (5) is 322 to 378 mm.

Typically, the length (C) from the bottom opening of the chamber (5) and a top of the siphon (6) is 138 to 162 mm.

If the length (C) from the bottom opening of the chamber (4) and a top of the siphon (6) is greater than that of 162 mm, then mixture present in the chamber is not mixed properly and gets overflowed from the chamber.

However, if the length (C) from the bottom opening of the chamber (4) and a top of the siphon (6) is lesser than that of 138 mm, then mixture present in the chamber is again not mixed properly and siphoned out from the chamber before homogeneous mixing.

It is observed that if the proportion of diameter (A), length (B) and length (C) changed other than that of mentioned critical ratio then the desired results as claimed were not achieved.

Accordingly, the present invention provides the simple, economic and eco-friendly dynamic mixer which prepares the desired quantity of curative composition and it has an outlet to transfer the composition at the desired place to avoid loss of material during transit. It eliminates the spillage of the curative composition while transferring to the desired place. It also eliminates jamming and thus eliminates the material loss thereof. It completely eliminates the human intervention in the manufacturing of the curative composition and dispensing thereof at desired places. The present invention allows using two or more curing agents to prepare the curative composition without jamming thereby eliminating the restriction on the number of curing agents used in the dynamic mixer to prepare the curative composition. The dynamic mixer of the present invention facilitates the preparation of the curative composition comprising substantially less amounts of curing agents in a proportion of 2.5:100 (curing agent(s)/system:resin system), thereby overcoming the proportion of the curing agent to the resin system used in the existing art and making it very efficient. The present dynamic mixer of the invention also facilitates mixing of at least two liquid components by replacing the curing agents and the resin system in the proportion 2.5:100 to prepare the homogeneous composition. It also facilitates mixing of at least five liquid components where at least one of the liquid components is used at least 2.5 phr. At such low concentration, the uniform mixing is carried out in the dynamic mixer of the invention to produce the homogeneous composition which is otherwise difficult to mix.

Thus, the dynamic mixer eliminated or substantially reduced the problems associated with the prior art thereby making the mixer less costly i.e. economic, eco-friendly and efficient.

### BEST MODE OR EXAMPLES FOR WORKING OF THE INVENTION

The present invention is described in the examples given below; further these are provided only to illustrate the invention and therefore should not be construed to limit the scope of the invention.

### Examples 1 to 5

The curative compositions were prepared according to the components and the formulations as disclosed in the Table 1 and Table 2 respectively.

TABLE 1
Components used in the curative composition

| | | |
|---|---|---|
| Sr. No. | Components | Amount |

| | |
|---|---|
| 1 | Part A |
| | Resin system |

| | | | |
|---|---|---|---|
| 1a | Polyester Resin (Netpol ™ 1011) | 100 | Parts |
| 1b | CaCO3 (filler) | 2.66 | PHR |

| | |
|---|---|
| 2 | Part B |
| | Curing system |

| | | | |
|---|---|---|---|
| 2a | TBPB | 1.4 | PHR |
| 2b | Release Oil (mould release agent) | 1.2 | PHR |
| 2c | BPO | 0.933 | PHR |

TABLE 2
Formulations of the curative composition

| | Formulations | | |
|---|---|---|---|
| | Part A | Part B | |
| | Amount discharged | Amount discharged | |
| | in the chamber | in the chamber | Part A:Part B |
| Examples | liter/minute | liter/minute | Proportion |
| 1 | 3.44 | 0.13 | 100:3.78 |
| 2 | 3.51 | 0.15 | 100:4.27 |
| 3 | 3.96 | 0.10 | 100:2.53 |
| 4 | 3.5 | 0.12 | 100:3.43 |
| 5 | 3.43 | 0.16 | 100:4.66 |

The formulations were prepared by mixing the part A and part B pumping into the chamber through inlet hoses (h2 and h1) and pumping means (p2 and p1) at the rate (liter/minute) indicated in Table 2 by using dynamic mixer. The chamber (5) of the dynamic mixer (100) had a diameter (A) of 125 mm. The length (B) of the stirring chamber (5) from a top closure to a bottom opening of the chamber (5) of the mixer was 350 mm. The length (C) from the bottom opening of the chamber (5) and a top of the siphon (6) of the mixer was 150 mm. The ratio of diameter (A):length (B):length (C) was 1:2.8:1.2. The residence time of the curing system and the resin system in chamber (5) was 40 to 67 seconds. The curative composition was siphoned out at rate of 3.56 liter/minute from the mixer through outlet hose and the composition was found to be a homogeneous composition. The composition was tested every 15 minutes with Differential Scanning calorimeter (DSC) machine for its homogeneity by monitoring heat of reaction in the phase transition and it was found to be similar. Thus, the compositions of examples 1 to 6 obtained were found to be homogenous.

### Example 6

The formulation according to example 1 was prepared by mixing the part A and part B pumping into the chamber though inlet hoses (h2 and h1) and pumping means (p2 and p1) at the rate (liter/minute) indicated in Table 2 by using dynamic mixer. The chamber (5) of the dynamic mixer (100) had a diameter (A) of 125 mm. The length (B) of the stirring chamber (5) from a top closure to a bottom opening of the chamber (5) of the mixer was 350 mm. The length (C) from the bottom opening of the chamber (5) and a top of the siphon (6) of the mixer was increased to 164 mm. The ratio of dimeter (A):length (B):length (C) was 1:2.8:1.31. We have observed that the mixture over flowed from the chamber and the curative composition siphoned out from the mixer was not a homogeneous composition.

### Example 7

The formulation according to example 1 was prepared by mixing the part A and part B pumping into the chamber though inlet hoses (h2 and h1) and pumping means (p2 and p1) at the rate (liter/minute) indicated in Table 2 by using dynamic mixer. The chamber (5) of the dynamic mixer (100) had a diameter (A) of 125 mm. The length (B) of the stirring chamber (5) from a top closure to a bottom opening of the chamber (4) of the mixer was 360 mm. The length (C) from the bottom opening of the chamber (5) and a top of the siphon (6) of the mixer was decreased to 136 mm. The ratio of diameter (A):length (B):length (C) was 1:2.88:1.09. The mixture from the chamber was siphoned out quickly and the curative composition siphoned out from the mixer was not a homogeneous composition.

### Example 8

The formulation according to example 1 was prepared by mixing the part A and part B pumping into the chamber though inlet hoses (h2 and h1) and pumping means (p2 and p1) at the rate (liter/minute) indicated in Table 2 by using dynamic mixer. The critical parameters of the dynamic mixer (100) were modified. The diameter (A) of the chamber (5) was 125 mm. The length (B) of the stirring chamber (5) from a top closure to a bottom opening of the chamber (5) was 350 mm and the length (C) from the bottom opening of the chamber (5) and a top of the siphon (6) was 140 mm. The ratio of diameter (A):length (B):length (C) was 1:2.8:1.12. The residence time of the curing system and the resin system in chamber (5) was 40 to 67 seconds. The curative composition was siphoned out at rate of 3.56 liter/minute from the mixer through outlet hose and the composition was found to be a homogeneous composition. The composition was tested every 15 minutes with Differential Scanning calorimeter (DSC) machine for its homogeneity by monitoring heat of reaction in the phase transition and it was found to be similar. Thus, the composition was found to be homogenous.

It was found that if the proportion of (A), (B) and (C) is in ratio of 1:(2.6-3.0):(1.1-1.3) then only the mixer facilitates the preparation of the homogeneous curative composition comprising substantially less amounts of curing agents/system in a proportion of 2.53 to 4.66:100 (curing system:resin system) which was otherwise difficult to mix.

Thus, the present invention has following advantages:

The simple, economic and eco-friendly dynamic mixer which prepares the desired quantity of curative composition and it has an outlet to transfer the composition at the desired place to avoid loss of material during transit.

It eliminates the spillage of the curative composition while transferring to the desired place.

It completely eliminates the human intervention in the manufacturing of the curative composition and dispensing thereof at desired places.

It also eliminates jamming and thus eliminates the material loss thereof.

The present invention allows using two or more curing agents to prepare the curative composition without jamming thereby eliminating the restriction on the number of curing agents used in the dynamic mixer to prepare the curative composition.

The present dynamic mixer of the invention also facilitates mixing of at least two liquid components by replacing the curing system and the resin system in the proportion 2.5:100 to prepare the homogeneous composition.

It also facilitates mixing of at least five liquid components where at least one of the liquid components is used at least 2.5 phr. At such low concentration, the uniform mixing is carried out in the dynamic mixer of the invention to produce the homogeneous composition which is otherwise difficult to mix.

1. A dynamic mixer to mix at least one curing system and at least one resin system in the proportion of at least 2.5:100 to obtain a homogenous curative composition, wherein said mixer comprises:
a) a stirring chamber (5) provided with a motorised stirrer (4) suspended from the top of the chamber (5) and a siphon (6) at the bottom;
b) at least one inlet hose (h1) connected to the stirring chamber at one end and pumping means (p1) at other end; the pumping means (p1) pump at least one curing system to the stirring chamber through the at least one inlet hose (h1);
c) at least one inlet hose (h2) connected to the stirring chamber at one end and pumping means (p2) at other end; the pumping means (p2) pump at least one resin system to the stirring chamber through the at least one inlet hose (h2); and
d) frame to setup the dynamic mixer.

2. The dynamic mixer as claimed in claim 1, wherein one arm (6a) of the siphon (6) is connected to the stirring chamber (5) at one end and other arm (6b) of the siphon (6) is connected the outlet pipe (7) at the other end to discharge the curative composition.

3. The dynamic mixer as claimed in claim 1, wherein the driving system of the stirrer may be mechanical including means to drive the wheel like shaft, driver, etc. or automated driving system.

4. The dynamic mixer as claimed in claim 1, wherein the outlet pipe connected to the siphon at the other arm (6b) dispenses the curative composition to a master tank through a primary dispensing port.

5. The dynamic mixer as claimed in claim 4, wherein the master tank comprises of several small dimensional portable tanks, said portable tanks are connected to the sub-dispensing inlet port of predefined height; said portable tanks are connected through the multiple sub-dispensing inlet ports to the primary dispensing port; said portable tanks are arranged at predefined intermittently elevated heights.

6. The dynamic mixer as claimed claim 1; wherein the curing system and resin system are pumped into the chamber by the pumping means p1 and p2 through inlet hoses h1 and h2 at a speed of 0.1 to 0.2 liter/minute and 3.4 to 3.55 litre/minute, respectively.

7. The dynamic mixer as claimed in claim 1; wherein the curative composition or homogeneous composition is siphoned out from the chamber through outlet hose at 3 to 4 liter/minute.

8. The dynamic mixer as claimed in claim 1; wherein the curing system and the resin system are mixed in the chamber (5) with a residence time in the range of 40 to 67 seconds to siphon out the homogenous composition.

9. The dynamic mixer as claimed in claim 1; wherein the diameter (A) of the stirring chamber (5) is 125 mm.

10. The dynamic mixer as claimed in claim 1; wherein the length (B) of the stirring chamber (5) from a top closure to a bottom opening of the chamber (5) is 322 to 378 mm.

11. The dynamic mixer as claimed in claim 1; wherein the length (C) from the bottom opening of the chamber (5) and a top of the siphon (6) is 138 to 162 mm.

12. The dynamic mixer as claimed in claim 1; wherein the proportion of diameter (A), length (B) and length (C) is in the ratio of 1:(2.6-3.0):(1.1-1.3).

13. The use of the dynamic mixer as defined in claim 1 for mixing at least one curing system and at least one resin system in a proportion of at least 2.5:100 to obtain a homogenous curative composition.

14. A method of obtaining a homogenous curative composition, the method comprising:
a) providing a dynamic mixer as defined in claim 1;
b) using the first pumping means (p1) to pump at least one curing system to the stirring chamber through the at least one inlet hose at a speed of 0.1 to 0.2 liter/minute;
c) using the second pumping means (p2) to pump at least one resin system to the stirring chamber through the at least one inlet hose (h2) at a speed of 3.4 to 3.55 litre/minute;
d) mixing the curing system and the resin system in the chamber (5) with a residence time in the range of 40 to 67 seconds; and then
e) siphoning out the resultant homogenous composition at 3 to 4 liter/minute.
